(19) United States
(12) Patent Application Publication
(10) Pub. No.: US 2005/0213466 A1
(43) Pub. Date: Sep. 29, 2005

(54) Data recording cartridge of the anti-compromise kind and associated anti-compromise processing

(75) Inventors: Francois Hommeau, Chatenay-Malabry (FR); Jean-Francois Sulzer, Sevres (FR)

Correspondence Address: PALMER & DODGE, LLP;KATHLEEN M. WILLIAMS, 111 HUNTINGTON AVENUE, BOSTON, MA, 02199, US

(73) Assignee: Enertec SA

(21) Appl. No.: 11/058,961

(22) Filed: Feb. 16, 2005

(30) Foreign Application Priority Data
Feb. 17, 2004 (FR) 04 01552

(51) Int. Cl. G11B 7/004

(52) U.S. Cl. 369/59.23; 369/53.21; 369/59.24

(57) ABSTRACT

The present invention relates to the incorporation in the removable cartridge C, as an interface between the usual storage STK (discs or static memory) and the outside of the aforementioned cartridge, of an encrypting-decrypting module MCD devoid of any non-volatile memory and capable of supporting an encoding key 10 which is assigned prior to each recording session so that all the stored data is encrypted and here is no trace of the aforementioned encoding key left the moment the first power supply cut-off to the module occurs, as a result of a general power supply cut-off, for example via connection 30, or as a result of the disengagement of the cartridge from the recorder.

### RELATED APPLICATIONS

This application claims priority from French Patent Application No. 04 01552, filed on Feb. 17, 2004, the entirety of which is hereby incorporated by reference.

### FIELD OF THE INVENTION

The present invention relates to the technical area of data recorders and more particularly to the cartridges used in such types of recorders.

### BACKGROUND OF THE INVENTION

Technical Area Covered by the Invention:

In the event of a “crash”, a capture, or an attempt by an unauthorized authority at reading data, the encoding key ceases to exist and the aforementioned unauthorized authority is left with only encrypted data, without the encoding key, therefore indecipherable, due to the immediate, automatic and totally autonomous reaction of the system of the present invention.

Posed Technical Problem:

In many military or security programs, data gathered by a recorder often results from the digitizing of signals on a removable medium and is confidential in nature.

Until recently, most data recorders used mainly magnetic tape and powerful demagnetizers, approved for such an application, to erase any residual trace of the tape recorded information, including analysis by non-conventional means. In this manner recorded magnetic tapes could be desensitized and lose their confidential nature.

On the other hand, these demagnetizers are heavy, a pollutant from an electromagnetic viewpoint and they consume a great deal of energy. Such characteristics make them unsuitable for placing them on board a vehicle and in particular for airborne applications. In the event of an accident or capture during the course of a mission, there is no practical desensitizing method and the only possible procedure consists in an ejection from the vehicle and the hope that the recorded medium will never be found again. In this scenario one can imagine however that the circumstances or the damage to the aircraft could be such or the incident could occur so fast that the ejection could not even take place.

Such data recorders using magnetic tape are gradually replaced by devices in which a removable storage medium (a cartridge) is based on standard format hard disks used in the data-processing industry or non-volatile semi-conductor based memories. Whether the coercive field strength of the magnetic materials involved is too high or the technology used is purely electrical, the demagnetizers are ineffective.

Considering that rewriting new data on the same medium is not enough to eliminate any detectable trace, a strict procedure combining consecutive blanking and rewriting is necessary to guarantee an actual obliteration of the information. This procedure achieved international consensus and is published by NATO under the AEDP-3 reference. However, in the event of a sudden accident, an attack or a “crash”, the pilot or the navigator may not have enough time to implement this type of procedure and once initiated it may not be completed due to the intended or not disruption of the power supply, or the fact that the blanking system was damaged in a combat situation or during a plain emergency landing.

In the case of an unmanned aircraft the risk is further increased due to the difficulty for the system to decide on its own to destroy the data that it had to gather.

Therefore, all these systems present a high risk of having the information held in the removable cartridge read by unauthorized personnel or authorities: one says then that such data is “compromised”. The handling of such cartridges in an unprotected environment is in any event conducive to the implementation of complex and costly security procedures.

Therefore, there is a significant and acknowledged need for removable cartridge data recorders which no longer present the risks of capture or compromise as described above.

### SUMMARY OF THE INVENTION

The present invention comprises incorporating in the removable cartridge C, as an interface between the usual storage STK (discs or static memory) and the outside of the aforementioned cartridge, an encrypting-decrypting module MCD, devoid of any non-volatile memory, and capable of supporting an encoding key 10 assigned prior to each recording session so that all the data stored is encrypted and that no trace of the aforementioned encoding key is left the moment the first power supply cut-off to the module occurs, as the result of a general power supply cut-off, for example, via connection 30, or as the result of the disengagement of the cartridge from the recorder.

It is preferable to carry out the implementation of the encoding key 10 by means of an electronic module 20 specially designed so that no trace is left of the aforementioned encoding key at the moment of the first module power supply cut-off, as a result of a main power supply cut-off for example via connection 30, or as the result of the disengagement of the cartridge from the recorder.

Therefore, in case of accident, capture, theft, and generally of an attempt at reading, whatever the case may be, by an unauthorized person, and similar risk of data compromise situations, the system of the present invention reacts automatically, instantly and totally autonomously, and the aforementioned unauthorized person is left with only encrypted data without any trace of the encoding key, therefore data which is strictly indecipherable.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 shows an embodiment of the data recorder of the present invention.

FIG. 2 shows an embodiment of the present invention wherein the power supply has been disrupted.

FIG. 3 shows an embodiment of the system of the present invention wherein the system reacts to an acceleration of the carrier vehicle.

FIG. 4 shows an embodiment of the present invention further comprising a mechanical armor-plating.

While the above-identified drawings set forth preferred embodiments of the present invention, other embodiments of the present invention are also contemplated, as noted in the discussion. This disclosure presents illustrative embodiments of the present invention by way of representation and not limitation. Numerous other modifications and embodiments can be devised by those skilled in the art which fall within the scope and spirit of the principles of the present invention.

### DETAILED DESCRIPTION

Data recorders of the present invention acquire diverse sources like digital data, video, analog signals into a digital proprietary or standardized format (such as STANAG 4283 for underwater acoustics, STANAG 4609 for digital video,STANAG 7024 for aerial reconnaissance) and make such data ready for transfer on a removable cartridge C which is exchangeable according to a standardized data processing interface, typically SCSI, IEEE 1394 or Fibre Channel; in any event these connections provide for fast data transmission rates which can be very high, in the order of one Gigabit per second and higher (STANAG 4575 standard).

Such recorders often contain functions to identically read back all or part of the acquired parameters, even when the recording is in progress, which is of particular interest in the case of surveillance missions. They are used on board all types of air, sea or land craft.

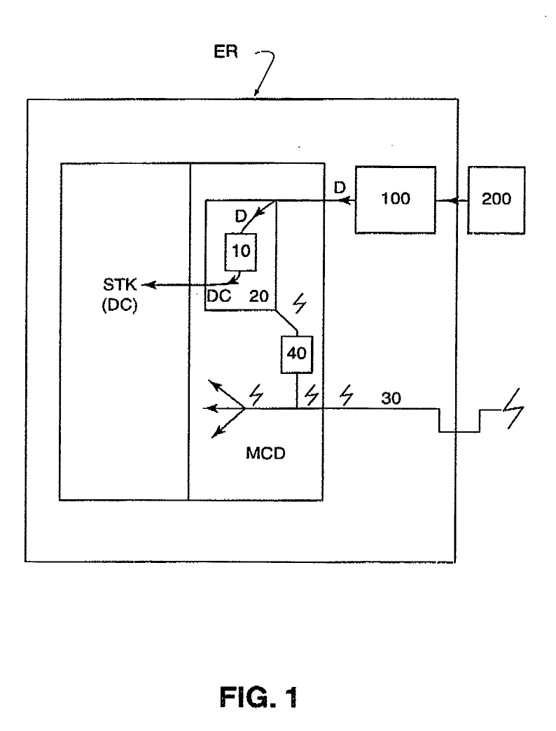

The data D is provided by known means of acquisition 100, physically integrated or not into the recorder, and data fed by apparatuses and systems 200 such as cameras, IR devices, and others which are not described here since they are well known, and the invention consists in incorporating inside the removable cartridge C, as an interface between the usual data storage STK (discs or static memory) and the entry of the aforementioned data D, an encrypting-decrypting module MCD as described above and devoid of any non-volatile memory. The encrypting algorithm retained for the module MCD can be of any type adapted for the application and approved by the Governmental Authorities for this particular use. In practice, the cartridge continues to interface like a standard data-processing peripheral according to the protocol and via a usual link. At the beginning of the recording session, the recorder ER provides, without preserving any trace of it and via this same link the encoding key 10 which it received in compliance with the security requirements and via the usual input methods, such as a keyboard, removable physical key, smart card. All the data D received at the cartridge is then consequently encrypted (DC) prior to being recorded and can be read back, decrypted and reconstructed by following the same process in reverse. This operation is graphically shown on attached FIG. 1.

If no encoding key is activated, the recorder can be programmed to operate in the usual way in a “non-encrypted” mode.

As soon as the first power supply disruption to the cartridge occurs, whether it is the result of a power cut-off at the recorder level, power cut-off at the mains or removal of the cartridge from its receptacle, all information, and in particular the encoding key, ceases to exist in the encrypting-decrypting module MCD, and just the encrypted information remains recorded on the cartridge (in the storage module STK), which becomes at that point, since it is no longer readable, unclassified or markedly less sensitive.

An activating device 40, itself activated by the aforementioned first power supply disruption to the cartridge can, if need be, activate module 20 which is adapted for erasing any and all trace of the encoding key 10.

The electric and electronic design of modules 20 and 40 is within the reach of those skilled in the art and therefore will not be described here, just as are all the variants, subsystems, improvements, auxiliary circuits etc. which will be known to those skilled in the art.

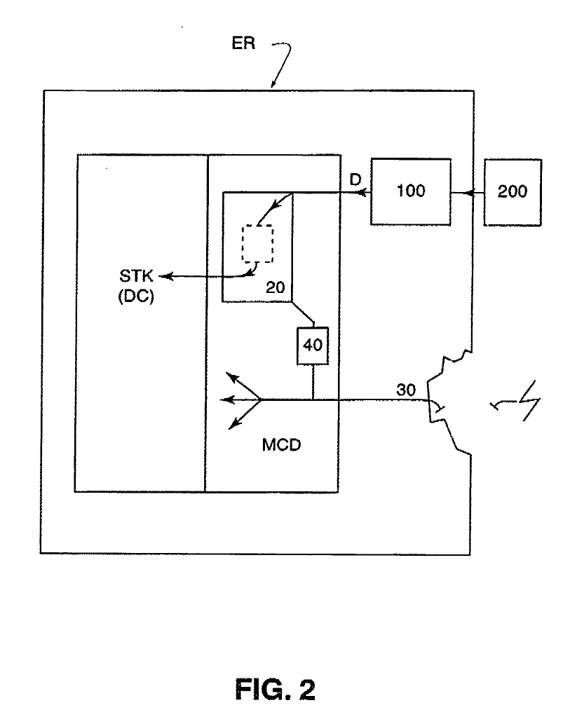

This is graphically shown on attached FIG. 2.

The advantage of this approach is obvious in the case of an aircraft “crash”: whether or not the flight crew (when one is present) had time to react, once the anti-compromise system is damaged, a power supply cut-off occurs at the latest at the time of ground impact, thus desensitizing the cartridge before it is possibly captured.

In order to cover the case of an unauthorized intervention on a recording chain which would have remained powered, the mechanical arrangement of the recorder can be such that physical access to the inside of the cartridge through disassembling is not physically possible without separating the aforementioned cartridge from its electrical connection and thus creating a power supply cut-off.

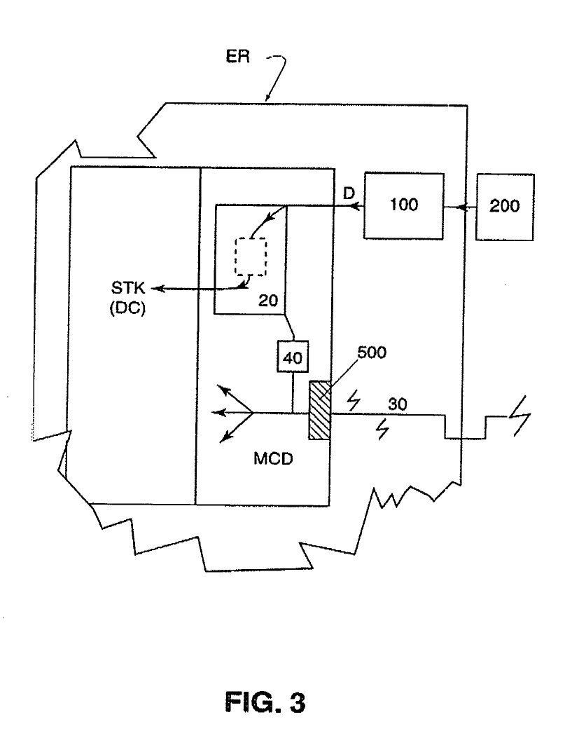

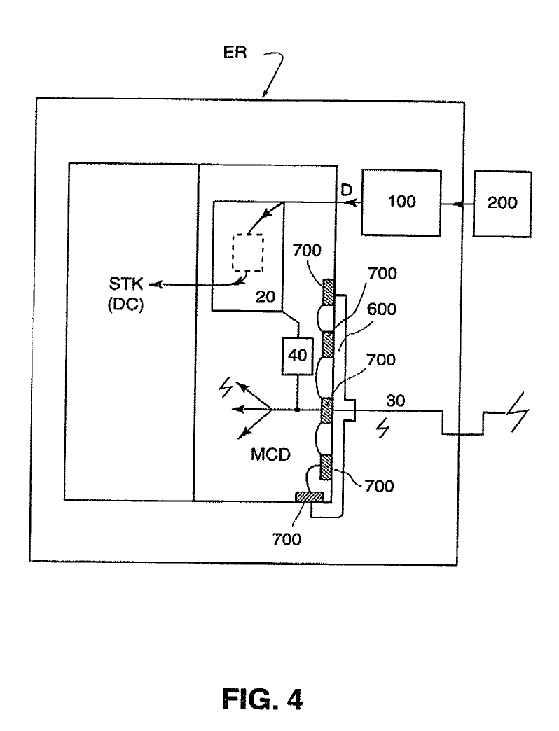

More generally and depending on the application, it is easy to provide for:
A time delay system which automatically cuts off the supply after a given and pre-programmed period of lack of communication between the recorder and the cartridge.
A system 500 (FIG. 3), reacting to accelerations, which cuts off the interface power supply in the event of an acceleration value definitely higher than that of accelerations registered during normal craft operation, as is the case during the course of a “belly landing” or a “crash” that does not result in a total destruction.
A mechanical armor-plating 600 (FIG. 4) preventing access to the cartridge power supply from the outside except through the forceful use of tools that is necessarily conducive to deformations, a deformation sensor 700 of the Wheatstone bridge circuit type or other would then cut off the power supply.
Other power supply shut-off devices activated under conditions known as abnormal, such as the exposure of a photo cell to daylight (day mission) or detecting a change in brightness (night mission)—by opening the access hatch, either after a regular landing, or in the event of an accident or capture).

In the same way, any cartridge that is not powered is automatically desensitized, which greatly facilitates its removal from the protected area for maintenance purposes in particular. When further desensitizing is called for, the usual methods (AEDP-3) remain practical with a reduced degree of rigorousness.

The implementation of the invention can be simply achieved by placing the necessary components of the module MCD on the miniature printed circuit board (presenting a thickness of a few millimeters) which usually controls the interfaces, without any impact on the cartridge construction or on the interfaces with the recorder. In many cases, the above encryption components could be of the type used to protect hard disks in portable recorders intended for sensitive applications. Considering that the only specific functionality required for the recorder (and therefore for the reader) consists in transmitting the key by means of software control, it is easy to see that a given recorder, or even recorders already in service, can equally work with standard cartridges or cartridges based on the present invention.

Finally one will notice that compared to the architecture where the data is fed to the recorder in encrypted form the present architecture obtained has the advantage of applying to all types of inputs, including analog ones and of decoupling the encrypting functions of the recording, which often correspond to very high data transmission rates, from those used by the communication channels.

The invention includes the cartridges which were just described, as well as the recorders adapted for receiving them, and the anti-compromise processing consisting in using such cartridges.

The cartridges were described as “removable” since this is the most common case; naturally, the invention also applies, mutatis-mutandis, to cartridges which would not be removable.

The present invention further provides a method of preventing a compromise of data. The method of the present invention comprises providing a data recording cartridge. Next, the method comprises acquiring a data by a known means of acquisition (discussed earlier in the specification). Further, the method comprises engaging an encrypting-decrypting module to the data recording cartridge and engaging an encoding key to the encrypting-decrypting module wherein the encoding key is provided prior to each recording session so that all acquired data becomes encoded. Finally, the method comprises removing any trace of the encoding key as the result of a power shut-off, wherein all data will be encrypted. Such a method prevent the compromise of sensitive data.

The invention also covers all the modes of construction and all the applications which will be readily available to those skilled in the art after reading the present application, from his/her own knowledge, and possibly from simple routine tests.

All patents, patent applications, and published references cited herein are hereby incorporated herein by reference in their entirety. While this invention has been particularly shown and described with references to preferred embodiments thereof, it will be understood by those skilled in the art that various changes in form and details may be made therein without departing from the scope of the invention encompassed by the appended claims.

1. A data recording cartridge fed with data from a data recorder, comprising:
an encrypting-decrypting module devoid of any non-volatile memory which acts as an interface between a usual storage medium and an outside of the data recording cartridge,
wherein the data recording cartridge is capable of operating an encoding key which is given prior to each recording session so that all the data stored is encoded and there is no trace of the aforementioned encoding key the moment a first power supply cut-off to the encrypting-decrypting module occurs.

2. The data recording cartridge of claim 1 wherein the cartridge is a removable cartridge.

3. The data recording cartridge of claim 1 further comprising a specially designed electronic module engaged to the encoding key so that there is no trace of the encoding key the moment the first power supply cut-off to the specially designed electronic module occurs, as a result of a main power supply cut-off.

4. The data recording cartridge of claim 1 wherein the data originates by a known means of acquisition.

5. The data recording cartridge of claim 4 wherein the known means of acquisition is data fed by a camera.

6. The data recording cartridge of claim 4 wherein the known means of acquisition is data fed by an IR device.

7. The data recording cartridge of claim 1 wherein the encrypting-decrypting module comprises an encryption algorithm.

8. The data recording cartridge of claim 1 wherein the cartridge continues to interface itself like a standard data-processing peripheral according to a protocol and via a usual link, wherein at a beginning of a recording session, a data recorder provides, without keeping any trace of it, via the usual link, the encoding key that it has received in compliance with a security requirement and via a usual input method and wherein all the data delivered to the data recording cartridge is then encrypted as a result prior to being recorded and can be read back, decrypted and reconstructed by following a reverse processing, knowing that if no encoding key is activated, the recorder can be programmed to operate in a “non-encrypted” mode according to the usual manner.

9. The data recording cartridge of claim 1 wherein as soon as the first power supply disruption to the data recording cartridge occurs, the encoding key is erased from the encrypting-decrypting module and only encrypted information remains recorded on the cartridge which becomes at that point, since it is no longer readable, unclassified or markedly less sensitive.

10. The data recording cartridge of claim 8 further comprises a system activator 40, wherein the system activator is activated by the first power supply disruption to the cartridge and once activated, activates the specially designed electronic module to erase any trace of the encoding key.

11. The data recording cartridge of claim 1 wherein a physical arrangement of the recorder is adopted so that physical access to the inside of the data recording cartridge through disassembling cannot be physically possible unless the data recording cartridge is separated from an electrical connection and thus undergo a power supply cut-off which erases any trace of the encoding key.

12. The data recording cartridge of claim 10 wherein a time delay system automatically initiates a power supply cut-off after a pre-programmed period of a lack of communication between the data recorder and the data recording cartridge.

13. The data recording cartridge of claim 10 wherein a system, initiates a power supply cut-off in an event of an aircraft acceleration value greater than a normal acceleration value registered during normal aircraft operation.

14. The data recording cartridge of claim 10 further comprising a mechanical armor-plating which prevents access to a cartridge power supply from the outside.

15. The data recording cartridge of claim 13 further comprising a deformation sensor wherein the deformation sensor would sense a deformation in the mechanical armor plotting and cut-off the power supply.

16. The data recording cartridge of claim 10 further comprising a power supply shut-off device which is activated under conditions known as abnormal, such as the exposure of a photocell to daylight or by detecting a change in brightness.

17. The data recording cartridge of claim 1 further comprising a miniature printed circuit board which comprises all necessary components of the encrypting-decrypting module.

18. The data recording cartridge of claim 1, wherein data is delivered to the data recording cartridge by a data recorder which acquires diverse sources of data and makes such data ready for transfer on the data recording cartridge which is interchangeable via a data processing type of standardized interface, such connections providing for a data transmission rate in the order of about a gigabit/second, wherein this same data recorder containing functions to identically read back all or part of the acquired parameters, even when the recording is in process.

19. A method of preventing a compromise of data, comprising:
providing a data recording cartridge;
acquiring a data by a known means of acquisition;
engaging an encrypting-decrypting module to the data recording cartridge;
engaging an encoding key to the encrypting-decrypting module wherein the encoding key is provided prior to each recording session so that all acquired data becomes encoded; and
removing any trace of the encoding key as the result of a power shut-off, wherein all data will be encrypted.
